(19) United States
(12) Patent Application Publication
(10) Pub. No.: US 2026/0348819 A1
(43) Pub. Date: Nov. 5, 2026

(54) CONDUCTIVE PARTICLE DETECTING DEVICE

(71) Applicant: Nabtesco Corporation, Tokyo (JP)

(72) Inventors: Koji NAKAMURA, Tokyo (JP); Kazuhiko SAKURAI, Tokyo (JP); Masaki HARADA, Tokyo (JP); Kazuki TAMURA, Tokyo (JP)

(21) Appl. No.: 19/646,220

(22) Filed: Apr. 13, 2026

(30) Foreign Application Priority Data
May 1, 2025 (JP) 2025-076006
Dec. 12, 2025 (JP) 2025-246997

(51) Int. Cl. G01N 15/06; G01N 15/00

(52) U.S. Cl. CPC G01N 15/0656; G01N 15/0606; G01N 2015/0053; G01N 2015/0687

(57) ABSTRACT

A conductive particle detecting device according to an embodiment includes: a mounting portion mounted to a speed reducer having conductive particles inside; and a detection unit aligned with the mounting portion and located inside the speed reducer, the detection unit being configured to detect the conductive particles. The detection unit includes: a plurality of electrode portions; a magnet portion for accumulating the conductive particles between adjacent ones of the plurality of electrode portions; and a detection circuit for detecting the conductive particles based on electrical resistance between adjacent ones of the plurality of electrode portions. The plurality of electrode portions are formed of a material that is non-magnetic and deformable and can be restored after deformation.

### CROSS-REFERENCE TO RELATED APPLICATIONS

This application is based on and claims the benefit of priority from Japanese Patent Application Serial Nos. 2025-076006 (filed on May 1, 2025) and 2025-246997 (filed on Dec. 12, 2025), the contents of which are incorporated herein.

### TECHNICAL FIELD

The present disclosure relates to a conductive particle detecting device.

### BACKGROUND

For example, speed reducers and other mechanical mechanisms are contained in mechanical devices, where the casing of the mechanical devices is filled with lubricant in order to prevent the mechanical mechanisms from wearing out. As such mechanical devices are used over a certain period of time, their mechanical parts may wear out or get damaged. If such occurs, conductive particles (metal powder) may mix into the lubricant. This may compromise the ability of the lubricant to save the mechanisms from being abraded.

Therefore, for such mechanical devices, it is desirable to externally detect that the amount of the metal powder mixed into the lubricant has exceeded a preset value. To address this problem, various conductive particle detecting devices have been proposed. For example, a conductive particle detecting device with an external thread part and a detection part aligned in the axial direction and integrated together is disclosed (see, for example, Japanese Patent Application Publication No. 2022-139964).

In this case, the detection part has a tubular cover, a plurality of electrodes supported by the cover, and a permanent magnet and detection circuit installed inside the cover. The plurality of electrodes each protrude radially outward from the peripheral wall of the cover and are arranged at intervals in a lubricant. The permanent magnet accumulates conductive particles in the lubricant between adjacent electrodes by a magnetic force. The detection circuit detects the conductive particles based on electrical resistance between the adjacent electrodes. Therefore, the conductive particles in the lubricant can be attracted by the permanent magnet, and the amount of attracted conductive particles can be sensed electrically.

When this type of conductive particle detecting device is mounted to a mechanical-device, the external thread part of the conductive particle detecting device is tightened externally of the casing into an internal thread part formed in the casing. This allows the conductive particle detecting device to be mounted to the mechanical device so that the detection part protrudes into the casing. As a result, the detection part is immersed in the lubricant.

However, in the conventional art, when mounting the conductive particle detecting device to the mechanical device, the electrodes could be deformed due to contact of the electrodes with the casing, for example. If the conductive particle detecting device with the deformed electrodes is mounted to the casing, the detection accuracy by the conductive particle detecting device can be decreased.

### SUMMARY

This disclosure provides a conductive particle detecting device that can prevent decrease in detection accuracy even if the electrodes are deformed when the conductive particle detecting device is mounted.

A conductive particle detecting device according to one aspect of the disclosure comprises: a mounting portion mounted to a mounting object, the mounting object having conductive particles inside; and a detection unit aligned with the mounting portion and located inside the mounting object, the detection unit being configured to detect the conductive particles. The detection unit includes: a plurality of electrode portions; a magnet portion for accumulating the conductive particles between adjacent ones of the plurality of electrode portions; and a detection circuit for detecting the conductive particles based on electrical resistance between adjacent ones of the plurality of electrode portions. The plurality of electrode portions are formed of a material that is non-magnetic and deformable and can be restored after deformation.

With this configuration, even if an electrode portion is deformed during mounting of the conductive particle detecting device to the mounting object, the electrode portion can be restored after the mounting. Therefore, it is possible to prevent decrease in detection accuracy of the conductive particle detecting device.

In the above configuration, the electrode portion may be formed of an elastically deformable material.

In the above configuration, the mounting portion may include an externally threaded portion. Each of the plurality of electrode portions may extend in a radial direction and protrude radially outward beyond a root of the externally threaded portion when viewed from an axial direction of the mounting portion.

In the above configuration, the detection unit may include a cover portion having a tubular shape and supporting the plurality of electrode portions, The cover portion may be coaxial with the mounting portion and may have slits into which the plurality of electrode portions are inserted. Each of the slits may extend obliquely so as to be closer to the mounting portion radially outward. Each of the plurality of electrode portions may include: a base portion extending along an inner surface of the cover portion; a folded portion extending obliquely from a distal end of the base portion, which is located on an opposite side to the mounting portion, so as to be inserted into corresponding one of the slits; and an electrode body extending radially outward from an end of the folded portion which is located on a radially outer side.

The conductive particle detecting device according to the present disclosure can prevent decrease in the detection accuracy even if the electrodes are deformed during mounting.

### BRIEF DESCRIPTION OF THE DRAWINGS

FIG. 1 schematically illustrates a configuration of a speed reducer relating to an embodiment of the present disclosure.

FIG. 2 is a perspective view showing a conductive particle detecting device relating to the embodiment of the present disclosure.

FIG. 3 is a sectional view along the line III-III in FIG. 2.

FIG. 4 is a sectional view along the line IV-IV in FIG. 2.

FIG. 5 is an exploded perspective view showing a cover relating to the embodiment of the present disclosure.

FIG. 6 is an enlarged plan view of the part VI in FIG. 4.

FIG. 7 is an explanatory view illustrating how conductive particles are detected by the conductive particle detecting device relating to the embodiment of the present disclosure.

FIGS. 8A-8C are explanatory diagrams illustrating a behavior of the conductive particle detecting device relating to the embodiment of the present disclosure during mounting to a casing. FIGS. 8A-8C sequentially show the changes in the behavior of the conductive particle detecting device.

FIG. 9 is a graph showing the changes in resistance sensed by a resistance detecting unit and temperature of the speed reducer in a first modification of the embodiment of the present disclosure.

### DESCRIPTION OF THE EMBODIMENTS

The following describes an embodiment of the present disclosure with reference to the drawings.

### Speed Reducer

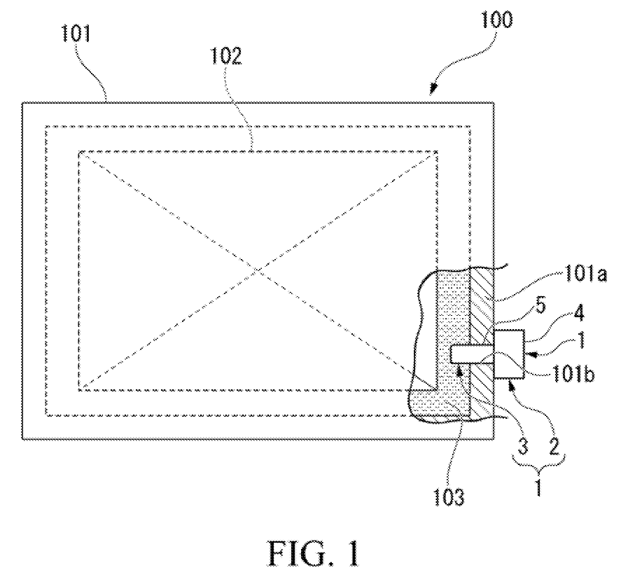

FIG. 1 schematically shows an example of a speed reducer 100 having a conductive particle detecting device 1 relating to the present disclosure. As shown in FIG. 1, the speed reducer 100 is an example of a mechanical device. The speed reducer 100 is used in, for example, the joints of industrial robots used in the production lines of plants. The speed reducer 100 includes a casing 101 to which the conductive particle detecting device 1 is mounted, and a speed reducing mechanism 102 housed within the casing 101. The speed reducing mechanism 102 reduces the speed of the rotation input from a power source, which is not shown, at a predetermined reduction ratio. The casing 101 is filled with a non-conductive lubricant 103. The speed reducing mechanism 102 is immersed in the lubricant 103. The speed reducing mechanism 102 employs grease or oil bath lubrication.

### Conductive Particle Detecting Device

The conductive particle detecting device 1 is mounted to a wall 101a of the casing 101. The conductive particle detecting device 1 is desirably mounted at a site where the lubricant 103 is highly flowable. The conductive particle detecting device 1 is configured to detect an abnormality of the speed reducer 100 by detecting the amount of conductive particles such as metal powder particles in the lubricant 103.

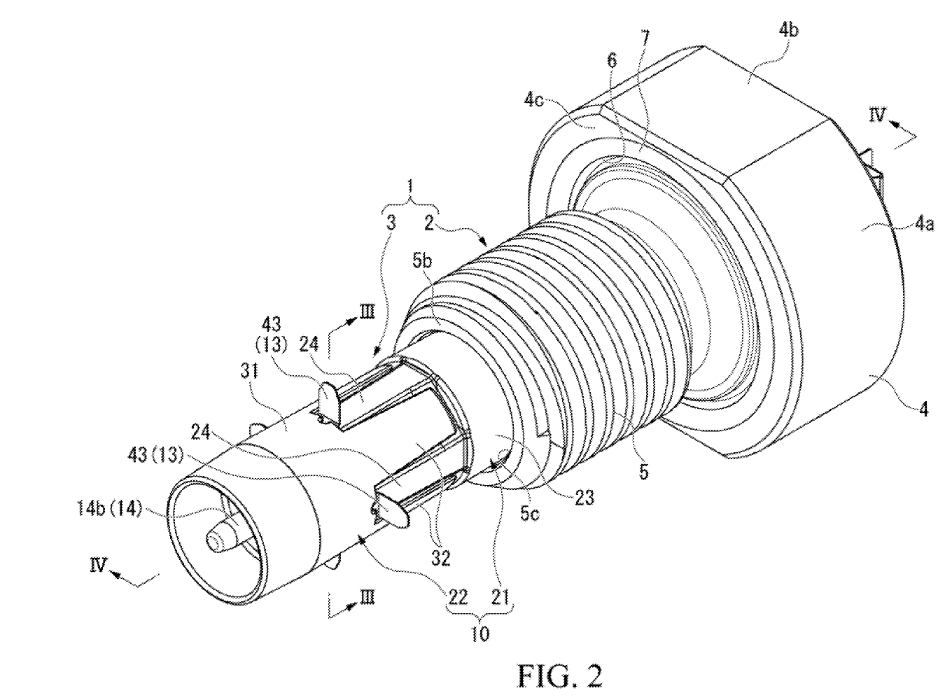

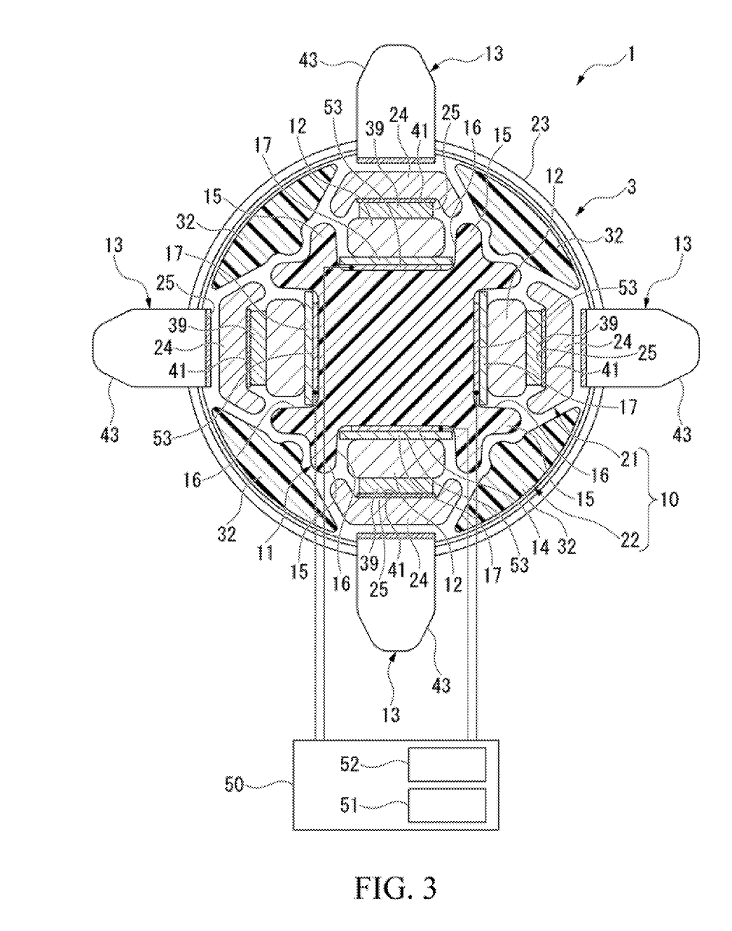

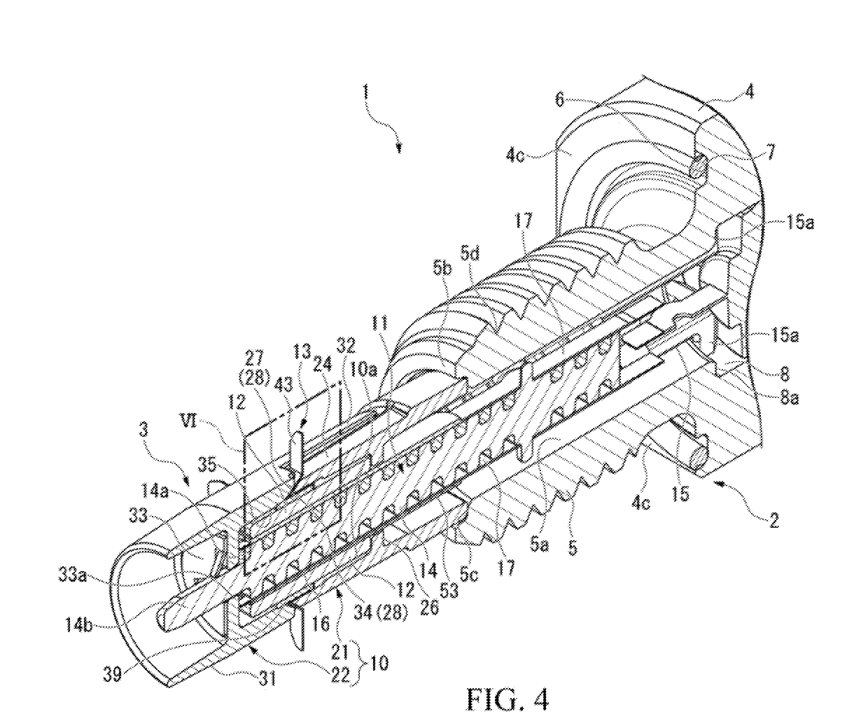

FIG. 2 is a perspective view of the conductive particle detecting device 1. FIG. 3 is a sectional view along the line III-III in FIG. 2. FIG. 4 is a sectional view along the line IV-IV in FIG. 2. As shown in FIGS. 2-4, the conductive particle detecting device 1 includes a mounting portion 2 mounted to the wall 101a of the casing 101, and a detection unit 3 aligned with the mounting portion 2 and integrated with the mounting portion 2.

### Mounting Portion

The mounting portion 2 includes a base portion 4 formed in a cylindrical shape and an externally threaded portion 5 disposed coaxially with the base portion 4. The externally threaded portion 5 is integrated with one end of the base portion 4 in the axial direction. In the following description, the axial direction of the mounting portion 2 is defined as the axial direction of the entire conductive particle detecting device 1. The radial direction of the mounting portion 2 is defined as the radial direction of the entire conductive particle detecting device 1. The circumferential direction of the mounting portion 2 is defined as the circumferential direction of the entire conductive particle detecting device 1.

The outer peripheral surface 4a of the base portion 4 includes a pair of flat portions 4b. The pair of flat portions 4b are opposed to each other in the radial direction of the mounting portion 2. The pair of flat portions 4b are used, for example, to mount the conductive particle detecting device 1 to the casing 101 (see below for details). The base portion 4 has a housing recess 8 formed therein. The housing recess 8 houses a part of the detection unit 3. An O-ring groove 6 is formed in the outer periphery of the end surface 4c of the base portion 4, which is located on the external thread 5 side. An O-ring 7 is placed in the O-ring groove 6.

The externally threaded portion 5 is tightened into an internally threaded portion 101b (see FIG. 1) formed in the wall 101a of the casing 101. In this manner, the conductive particle detecting device 1 can be mounted to the wall 101a of the casing 101. The externally threaded portion 5 is shaped like a cylinder having a through hole 5a formed therein. The through hole 5a extends along the axial direction of the externally threaded portion 5 and communicates with the housing recess 8.

The externally threaded portion 5 has a distal end portion 5b located opposite the base portion 4, and the distal end portion 5b has a cover receiving recess 5c formed therein. The cover receiving recess 5c is located coaxially with the through hole 5a. The cover receiving recess 5c has a circular shape when viewed in the axial direction. The inner diameter of the cover receiving recess 5c is larger than the inner diameter of the through hole 5a. The cover receiving recess 5c communicates with the through hole 5a. The cover receiving recess 5c thus configured receives a cover portion 10 (described below) fitted therein.

### Detection Unit

The detection unit 3 is provided on the distal end portion 5b of the externally threaded portion 5. The detection unit 3 includes the cover portion 10, a support portion 11, four magnet portions 12, four electrode portions 13, and a detection circuit 50. The cover portion 10 is fitted into the cover receiving recess 5c of the externally threaded portion 5. The cover portion 10 is shaped like a cylinder having a through hole 10a formed therein. The through hole 10a extends along the axial direction of the cover portion 10. The support portion 11 is inserted into the through hole 10a of the cover portion 10 and into the through hole 5a of the externally threaded portion 5. The four magnet portions 12 are positioned between the support portion 11 and the cover portion 10 and are supported by the support portion 11. The four electrode portions 13 are supported by the cover portion 10. The detection circuit 50 is electrically connected to the electrode portions 13.

### Support Portion

The support portion 11 is made of, for example, a resin. The support portion 11 has a square bar-shaped support body 14 and four support legs 15. Each of the four support legs 15 is integrated with one of the four corners of the support body 14 when the support body 14 is viewed in the axial direction. The support body 14 extends from an axially middle portion of the through hole 5a of the externally threaded portion 5 into the through hole 10a of the cover portion 10. The support body 14 is thus inserted into the large portion of the through hole 10a in the cover portion 10. The central axis of the support body 14 is aligned with the central axis of the externally threaded portion 5. The support body 14 has a distal end portion 14a located opposite the base portion 4, and the distal end portion 14a has a support shaft 14b protruding therefrom. The support shaft 14b is coaxial with the support body 14. The support shaft 14b is used to support the cover portion 10 on the support body 14 (details are described below).

The four support legs 15 extend over the entire axial length of the support body 14. Furthermore, the four support legs 15 extend from the support body 14 toward the base portion 4. Each of the support legs 15 has, on an end portion thereof on the base portion 4 side, an outer flange 15a integrated therewith so as to protrude radially outward. The outer flange 15a overlies, in the axial direction, a bottom surface 8a of the housing recess 8. The bottom surface 8a is one of the inner wall surfaces forming the housing recess 8 that is located on the detection unit 3 side and faces in the axial direction. The support portion 11 is thus positioned at least in the axial direction.

The support body 14 and the support legs 15 form magnet housing recesses 16 on each of the four sides of the support body 14. The four magnet housing recesses 16 are long in the axial direction and arranged at equal intervals in the circumferential direction. In each of the magnet housing recesses 16, a relay piece 17 made of a metal magnetic material is provided. The relay pieces 17 are each shaped like a plate. The magnet portions 12 are located on the relay pieces 17.

### Magnet Portions

Each of the magnet portions 12 is shaped like a bar long in the axial direction, so as to conform to the shape of the magnet housing recess 16. The magnet portion 12 is a conductive magnet. The magnet portion 12 has the properties of a magnet without receiving an external magnetic field or current supply. The magnet portion 12 is adhered and thus fixed to the relay piece 17 through magnetic force.

### Cover Portion

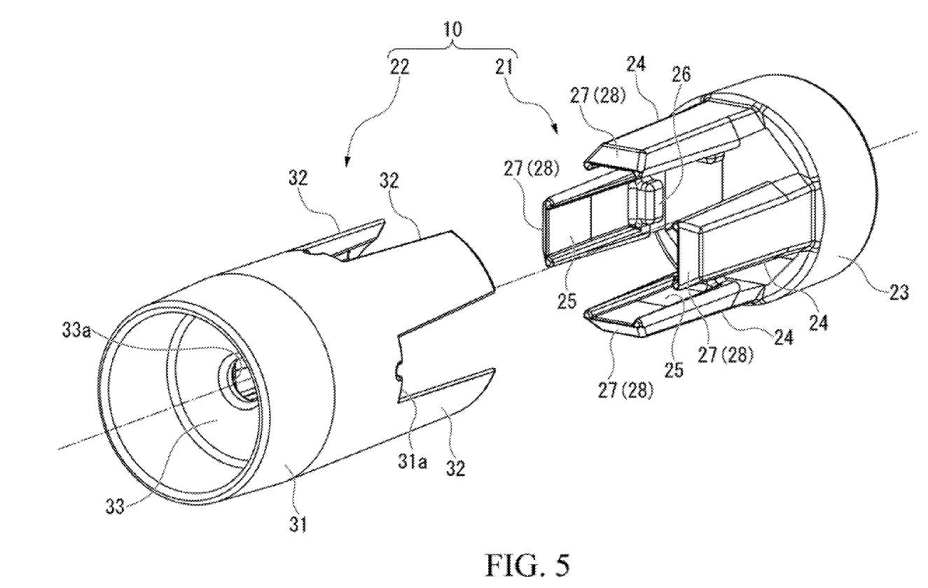

FIG. 5 is an exploded perspective view of the cover portion 10. The cover portion 10 is made of, for example, a resin. The cover portion 10 may have an oil-repellent surface, for example. As shown in FIGS. 2-5, the cover portion 10 includes a first cover 21 and a second cover 22 arranged in the axial direction. The first cover 21 and the second cover 22 can be separated in the axial direction. Thus, the cover portion 10 is separably constituted by the first cover 21 and the second cover 22.

The first cover 21 is positioned on the mounting portion 2 side. The first cover 21 includes a first cylindrical portion 23 and four first cover legs 24. The four first cover legs 24 extend in the axial direction from the end of the first cylindrical portion 23 that is located on the second cover 22 side toward the second cover 22. The end of the first cylindrical portion 23 that is located on the externally threaded portion 5 side is fitted into the cover receiving recess 5c.

The four first cover legs 24 are arranged at equal intervals in the circumferential direction. The four first cover legs 24 are located radially outside the magnet portions 12 when the first cover 21 is mounted onto the externally threaded portion 5. Each of the first cover legs 24 is shaped like a plate. For example, the first cover leg 24 is shaped like a plate with a thickness along the thickness direction equal to a width along the radial direction. The first cover leg 24 is elastically deformable in the radial direction. Furthermore, the first cover leg 24 presses the magnet portion 12 from the radially outer side toward the radially inner side by elastic restoring deformation. Thus, the first cover leg 24 slightly elastically presses the magnet portion 12.

The inner peripheral surface of the first cylindrical portion 23 and the inner peripheral surfaces of the first cover legs 24 form a through hole 10a of the cover portion 10. The inner peripheral surface of each first cover leg 24 has a first spacer housing recess 25 formed therein, which extends over a large part of the middle of the inner peripheral surface in the circumferential direction. The first spacer housing recess 25 extends over the entire axial length of the first cover leg 24. The first spacer housing recess 25 houses a spacer 39 (described below) and the magnet portion 12.

The first spacer housing recess 25 has a restraining projection 26 formed at the middle in the axial direction. The restraining projection 26 extends over the entire circumferential length of the first spacer housing recess 25. The restraining projection 26 is positioned on the externally threaded portion 5 side of the magnet portion 12 when the first cover 21 is mounted onto the externally threaded portion 5. In this manner, the restraining projections 26 can restrain the movement of the magnet portions 12 in the axial direction.

The distal end of each first cover leg 24 located on the second cover 22 side has a first sloped surface 27. The first sloped surface 27 is sloped gradually inward in the radial direction toward the distal end of the first cover leg 24. The first sloped surface 27 cooperates with the second cover 22 to form a slit 28. The electrode portions 13 are each inserted in the slit 28 and supported in this state. Details of the slits 28 and the electrode portions 13 will be described below.

The second cover 22 includes a second cylindrical portion 31 and four second cover legs 32. The four second cover legs 32 extend in the axial direction from the end of the second cylindrical portion 31 that is located on the first cover 21 side toward the first cover 21. A sealing plate 33 is integrally formed with the second cylindrical portion 31 at the middle in the axial direction. A through hole 33a is formed in the sealing plate 33 at the middle in the radial direction and extends through the sealing plate 33 in the thickness direction (axial direction). The support shaft 14b of the support portion 11 is inserted into the through hole 33a. The second cover 22 is thus supported by the support portion 11 (support body 14).

The inner peripheral surface of the second cylindrical portion 31 has second spacer housing recesses 35 formed therein at positions corresponding to the first spacer housing recesses 25 of the first cover legs 24. The second spacer housing recesses 35 each extend from the sealing plate 33 to the end 31a of the second cylindrical portion 31 (the end 31a of the second cylindrical portion 31 located on the first cover 21 side). The second spacer housing recesses 35 are axially aligned with the first spacer housing recesses 25. The second spacer housing recesses 35 house a spacer 39 (described below).

The portions of the end 31a of the second cylindrical portion 31 that correspond to the second spacer housing recesses 35 are axially opposed to the first sloped surfaces 27 of the first cover legs 24. The portions of the end 31a that are axially opposed to the first sloped surfaces 27 have second sloped surfaces 34. Each of the second sloped surfaces 34 is gradually sloped radially outward toward the first cover leg 24, so as to conform to the first sloped surface 27. The second sloped surface 34 faces the first sloped surface 27 in the axial direction with a predetermined gap therebetween. Thus, a slit 28 is formed between the first sloped surface 27 and the second sloped surface 34, which extends obliquely so as to be closer to the mounting portion 2 radially outward.

The four second cover legs 32 are arranged at equal intervals in the circumferential direction. The four second cover legs 32 are located to fill the spaces between adjacent ones of the first cover legs 24 in the circumferential direction while the second cover 22 is supported on the support portion 11. Each of the second cover legs 32 is shaped like a plate. For example, the second cover leg 32 is shaped like a plate with a thickness along the thickness direction equal to a width along the radial direction. The inner peripheral surface of the second cylindrical portion 31 and the inner peripheral surfaces of the second cover legs 32 form the through hole 10a of the cover portion 10.

### Electrode Portions

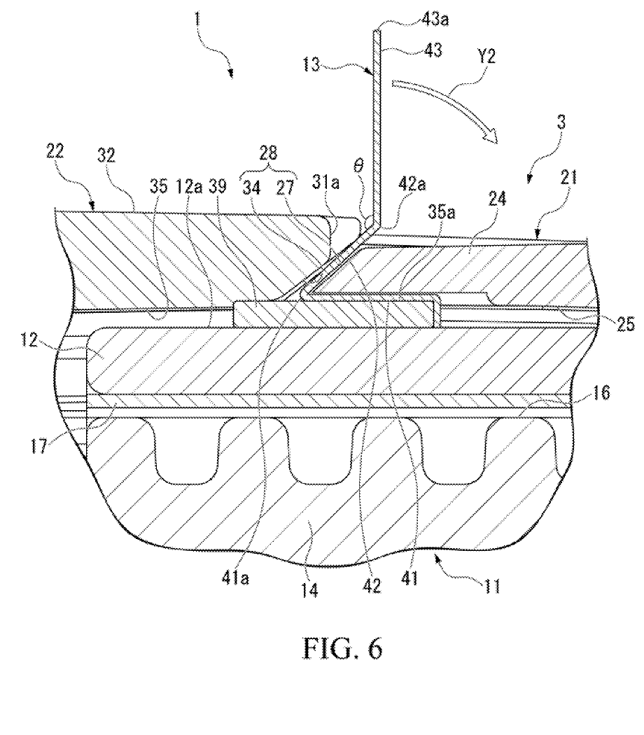

FIG. 6 is an enlarged plan view of the part VI in FIG. 4. As shown in FIGS. 2, 3, 4 and 6 each of the electrode portions 13 is positioned on the outer surface 12a of the magnet portion 12 on the radially outer side via a spacer 39. The spacer 39 is shaped like a long plate in the axial direction. The spacer 39 is housed in the first spacer housing recess 25 of the first cover 21 and the second spacer housing recess 35 of the second cover 22. The spacer 39 is formed of a conductive non-magnetic material such as brass, aluminum, or copper, for example.

The electrode portion 13 is formed by bending a conductive, non-magnetic, metal plate such as a stainless steel plate. Specifically, the electrode portion 13 is formed of a metal plate bent by pressing, for example. The electrode portion 13 has a thickness of, for example, about 0.1 mm. The electrode portion 13 is elastically deformable. The electrode portion 13 may have an oil-repellent surface, for example. More specifically, the electrode portion 13 includes a base portion 41, a folded portion 42, and an electrode body 43. The electrode portion 13 is formed by integrally molding the base portion 41, the folded portion 42, and the electrode body 43.

The base portion 41 is located on the outer surface 35a of the spacer 39 on the radially outer side and extends along the outer surface 35a and the inner peripheral surface of the first cover leg 24. The folded portion 42 is folded back from the distal end 41a of the base portion 41, which is located on the opposite side to the mounting portion 2, to extend obliquely outward in the radial direction. The electrode body 43 extends radially outward from the outer end 42a of the folded portion 42, which is located on the radially outer side.

The folded portion 42 is inserted in the slit 28. Thus, the electrode portion 13 is supported by the cover portion 10. The outer end 42a of the folded portion 42 is located at the outer peripheral surfaces of the first cover 21 and the second cover 22. Accordingly, the electrode body 43 protrudes radially outward beyond the outer peripheral surface of the cover portion 10.

The electrode body 43 is positioned so that the thickness direction of the electrode body 43 coincides with the axial direction. Therefore, the angle θ between the folded portion 42 and the electrode body 43 is an obtuse angle. The distal end 43a side of the electrode body 43, which is located on the radially outer side, is tapered radially outward when viewed from the axial direction (see FIG. 3). Furthermore, the distal end 43a of the electrode body 43 protrudes radially outward beyond the root 5d (see FIG. 4) of the externally threaded portion 5 in the mounting portion 2 when viewed from the axial direction.

As mentioned previously, the first cover leg 24 slightly presses the magnet portion 12 from the radially outer side toward the radially inner side in an elastic manner. Accordingly, the base portion 41 of the electrode portion 13 and the spacer 39 are elastically pressed toward the magnet portion 12 by the first cover leg 24. This ensures sufficient contact of the magnet portion 12 with the base portion 41 and the spacer 39. Thus, the electrode portion 13 and the magnet portion 12 are mutually conductive. Since the electrode portion 13 and the spacer 39 are non-magnetic, the electrode portion 13 is electrically connected to the magnet portion 12 without being magnetized.

### Detection Circuit

As shown in FIG. 3, the detection circuit 50 has a circuit board 53, a resistance detecting unit 51 and a power supply 52. The circuit board 53 is connected to the relay pieces 17, and the resistance detecting unit 51 and power supply 52 are connected to the relay pieces 17 via the circuit board 53. The power supply 52 applies voltage to any one of the electrode portions 13. The resistance detecting unit 51 is configured to detect the resistance between the electrode portion 13 to which voltage is applied and an adjacent one of the other electrode portions 13 in the circumferential direction. The detection circuit 50 thus senses how the detected resistance changes and, based on it, can sense the amount of conductive particles such as metal powder particles in the lubricant 103 in the speed reducer 100. In this way, the conductive particle detecting device 1 detects an abnormality of the speed reducer 100. The following specifically describes how the conductive particle detecting device 1 detects an abnormality of the speed reducer 100.

### How Conductive Particle Detecting Device Detects Abnormality of Speed Reducer

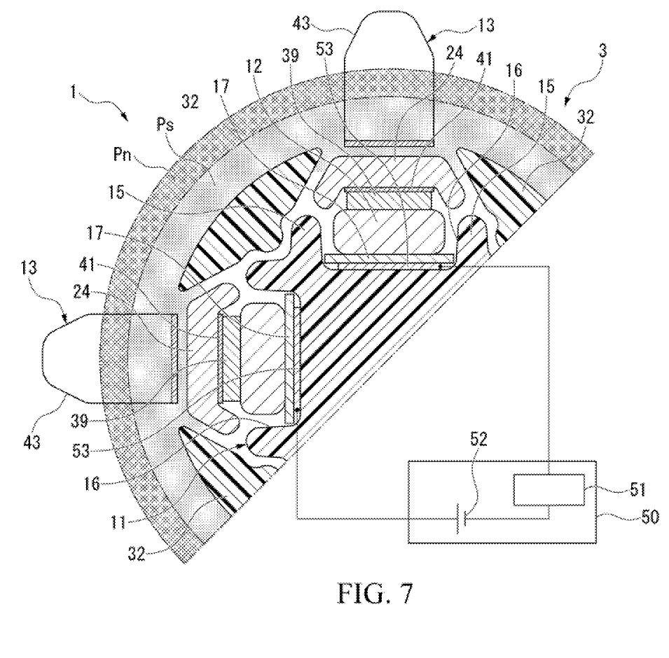

FIG. 7 is an explanatory view illustrating how conductive particles are detected by the conductive particle detecting device 1. FIG. 7 is an enlarged view showing a part of FIG. 3. The following first describes initial abrasion powder particles (metal powder particles) having a fine particle size, which are produced when the speed reducer 100 is used for the first time (in other words, during the initial phase of operation). The initial abrasion powder particles are fine metal powder particles with a particle size of, for example, less than 10 μm (usually less than approximately 2 μm) and has little adverse effects on the operation of the speed reducer 100.

As shown in FIGS. 1 and 7, the detection unit 3 is disposed to protrude into the casing 101 of the speed reducer 100, so that the detection unit 3 is immersed in the lubricant 103. Under these conditions, the initial abrasion powder particles are magnetically attracted to the magnet portions 12 of the conductive particle detecting device 1. Therefore, the initial abrasion powder particles adhere to the outer peripheral surface of the cover portion 10, that is, the outer peripheral surfaces of the first cover legs 24 and the second cover legs 32, forming a lower layer Ps. The adhering initial abrasion powder particles are surrounded by the lubricant 103, which forms a non-conductive layer. During the initial phase of operation, the resistance detecting unit 51 detects an infinite resistance since the lubricant 103 is non-conductive. In addition, initial abrasion powder particles adhere with a relatively weak force. Therefore, only a small amount of initial abrasion powder particles is deposited between adjacent ones of the electrode portions 13 in the circumferential direction.

Since the electrode portions 13 are made of a non-magnetic conductive material, there is no chance that the electrode portions 13 are magnetized under the influence of the magnetic force produced by the magnet portions 12. This prevents the initial abrasion powder particles from adhering to the electrode bodies 43 of the electrode portions 13, which protrude from the outer peripheral surface of the cover portion 10. As a result, the event of the electrode bodies 43, for example, being covered with initial abrasion powder particles can be prevented as much as possible during the initial phase of operation of the speed reducer 100.

The following now describes the over-time metal powder particles. The over-time metal powder particles are metal powder particles that are generated after a certain period of time elapses after the initial abrasion powder particles are generated. In other words, the over-time metal powder particles include metal powder particles (abrasion powder particles) and broken fragments (metal fragments) that are generated as the speed reducer 100 is used in an ordinary manner. The over-time metal powder particles have a large particle size, for example, 10 μm or more. Therefore, the over-time metal powder particles are easily affected by the magnetic force produced by the magnet portions 12. The over-time metal powder particles push away the non-conductive lubricant and attract each other.

As the amount of over-time metal powder particles in the lubricant 103 increases, the over-time metal powder particles are magnetically attracted to the magnet portions 12. The over-time metal powder particles adhere to the outer peripheral surface of the cover portion 10 between adjacent ones of the electrode portions 13 in the circumferential direction. The over-time metal powder particles are subject to the magnetic force produced by the magnet portions 12 and deposited on top of the lower layer Ps, which adheres to the outer peripheral surface of the cover portion 10. The over-time metal powder particles thus form an upper layer Pn on top of the lower layer Ps.

When the amount of over-time metal powder particles deposited on the outer peripheral surface of the cover portion 10 reaches or exceeds a specified amount, the resistance detecting unit 51 detects a resistance equal to or less than a specified value. When the detected resistance reaches or falls below the specified value, the detection circuit 50 determines that the speed reducer 100 has an abnormality. In this manner, the conductive particle detecting device 1 can detect an abnormality of the speed reducer 100.

For example, if the output rotational speed of the speed reducer 100 is very low, metal powder particles having a larger size than the initial abrasion powder particles but having almost no electrical conductivity may be generated in a large amount during the period after the initial abrasion powder particles are generated until the over-time metal powder particles are generated. In such cases, the electrode body 43 could be covered with the metal powder particles or the initial abrasion powder particles. When the electrode body 43 is covered with the metal powder particles that have almost no adverse effect on the operation of the speed reducer 100, the detection circuit 50 cannot accurately detect the adhesion of the over-time metal powder particles.

With this respect, in the conductive particle detecting device 1 of the embodiment, the distal end 43a of the electrode body 43 protrudes radially outward beyond the root 5d of the externally threaded portion 5 in the mounting portion 2 when viewed from the axial direction. This configuration prevents the electrode body 43 from being covered with the metal powder particles that have almost no adverse effect on the operation of the speed reducer 100. Furthermore, this configuration can prevent decrease in detection accuracy of the conductive particle detecting device 1. The following describes the behavior of the conductive particle detecting device 1 during mounting to the speed reducer 100.

### Behavior of Conductive Particle Detecting Device During Mounting

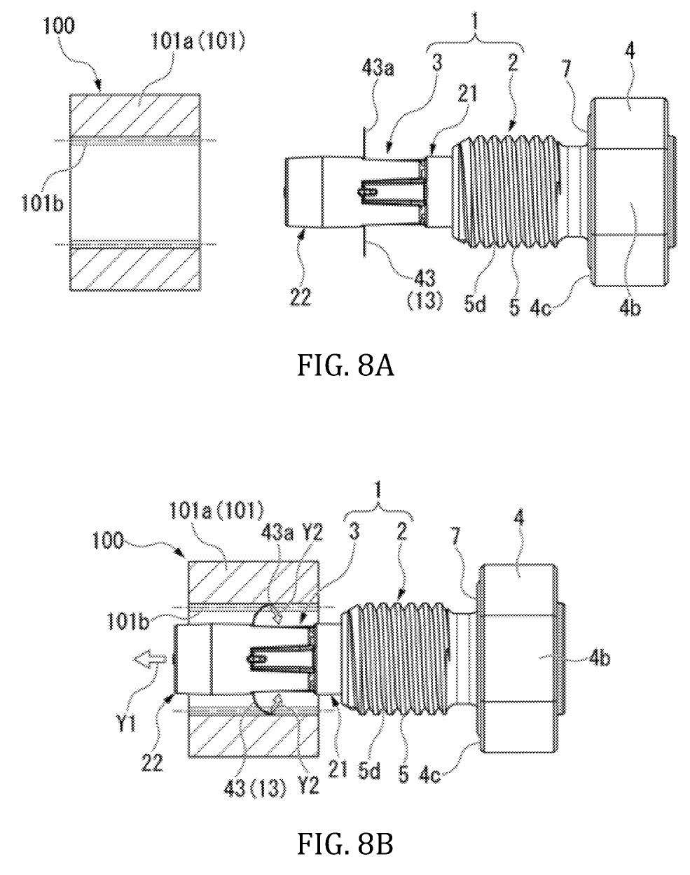

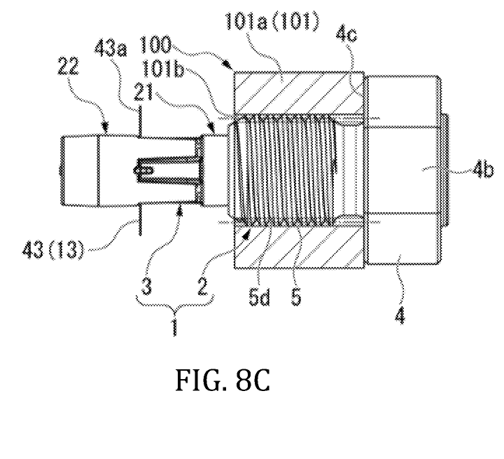

FIGS. 8A-8C are explanatory diagrams illustrating a behavior of the conductive particle detecting device 1 during mounting to the casing 101 in the speed reducer 100. FIGS. 8A-8C sequentially show the changes in the behavior of the conductive particle detecting device 1. As shown in FIG. 8A, the first step of mounting the conductive particle detecting device 1 to the casing 101 is to direct the detection unit 3 of the conductive particle detecting device 1 to the internally threaded portion 101b formed in the wall 101a of the casing 101.

Next, as shown in FIG. 8B, the detection unit 3 is inserted into the internally threaded portion 101b (see arrow Y1 in FIG. 8B). At this time, the distal end 43a of the electrode body 43 protrudes radially outward beyond the root 5d of the externally threaded portion 5 in the mounting portion 2 when viewed from the axial direction. Thus, the electrode body 43 contacts the internally threaded portion 101b.

Therefore, when the detection unit 3 is inserted into the internally threaded portion 101b, the electrode body 43 is elastically deformed so that it collapses toward the mounting portion 2 (see arrows Y2 in FIG. 8B, also see FIG. 6). The angle θ between the folded portion 42 and the electrode body 43 is an obtuse angle. Therefore, the electrode body 43 is elastically deformed so that it smoothly collapses toward the mounting portion 2. No force is applied to the electrode body 43 to bend it in an unreasonable direction.

When the detection unit 3 is further inserted, the externally threaded portion 5 of the mounting portion 2 butts against the internally threaded portion 101b of the wall 101a. Then, the externally threaded portion 5 is tightened into the internally threaded portion 101b. At this time, the mounting portion 2 can be rotated by applying a tool onto a pair of flat portions 4b formed on the base portion 4 of the mounting portion 2. This allows the externally threaded portion 5 to be smoothly tightened into the internally threaded portion 101b. As shown in FIG. 8C, when the externally threaded portion 5 is fully tightened into the internally threaded portion 101b, the end surface 4c of the base portion 4 butts against the wall 101a. The O-ring 7 provided on the end surface 4c ensures sealing between the wall 101a of the casing 101 and the conductive particle detecting device 1.

The portion of the detection unit 3 where the electrode body 43 is provided protrudes fully to the inside of the wall 101a through the internally threaded portion 101b. This causes the electrode body 43 to experience an elastic restoring force, which restores the electrode body 43 to the state prior to mounting to the casing 101. Therefore, the distal end 43a of the electrode body 43 can be restored to the state in which it protrudes radially outward beyond the root 5d of the externally threaded portion 5 in the mounting portion 2 when viewed from the axial direction. Thus, the mounting of the conductive particle detecting device 1 to the casing 101 is completed.

As described above, in the conductive particle detecting device 1 of the embodiment, the electrode portion 13 is formed of a material that is non-magnetic and deformable and can be restored after deformation. Therefore, even if the electrode portion 13 is deformed during mounting of the conductive particle detecting device 1 to the casing 101 of the speed reducer 100, the electrode portion 13 can be restored after the mounting. Therefore, it is possible to prevent decrease in detection accuracy of the conductive particle detecting device 1.

The electrode portion 13 is formed of an elastically deformable material. Therefore, the electrode portion 13 can be manufactured easily. Furthermore, plastic deformation of the electrode portion 13 can be prevented. Therefore, even if the electrode portion 13 is deformed, it can be ensured that the electrode portion 13 is restored after the mounting.

The electrode portion 13 extends in the radial direction and protrudes radially outward beyond the root 5d of the externally threaded portion 5 when viewed from the axial direction. This configuration allows the electrode portion 13 to extend as long as possible. Thus, it can be prevented that, for example, the electrode body 43 of the electrode portion 13 is covered with the initial abrasion powder particles that do not need to be detected. Therefore, it is possible to prevent decrease in detection accuracy of the conductive particle detecting device 1.

The cover portion 10 has the slit 28 for supporting the electrode portion 13. The slit 28 extends obliquely so as to be closer to the mounting portion 2 radially outward. In other words, the slit 28 extends obliquely toward the direction opposite to the direction in which the conductive particle detection device 1 is inserted into the casing 101. The electrode portion 13 is formed of a plate (metal plate) bent by pressing, for example, and includes the base portion 41, the folded portion 42, and the electrode body 43.

The folded portion 42 extends obliquely outward in the radial direction from the distal end 41a of the base portion 41 on the opposite side to the mounting portion 2, so as to be inserted into the slit 28. Thus, the angle θ between the folded portion 42 and the electrode body 43 is an obtuse angle. Therefore, when the externally threaded portion 5 of the conductive particle detecting device 1 is tightened into the internally threaded portion 101b of the casing 101, the electrode body 43 of the electrode portion 13 can smoothly conduct elastic deformation. As a result, the electrode portion 13 is not forced into unreasonable elastic deformation, preventing damage to the electrode portion 13. Therefore, it is possible to prevent decrease in detection accuracy of the conductive particle detecting device 1. It is also possible to improve the ease of mounting the conductive particle detecting device 1.

### First Modification

In the above embodiment, description was made for the case in which, when the amount of deposited over-time metal powder particles of the speed reducer 100 reaches or exceeds a specified amount, the resistance detecting unit 51 detects a resistance equal to or less than a specified value, and the detection circuit 50 determines that the speed reducer 100 has an abnormality. However, this case is not limitative, and in addition to the determination based on the resistance value detected by the resistance detecting unit 51, the detection results of various sensors may be used to determine an abnormality in the speed reducer 100. Examples of the various sensors include a temperature sensor that detects the temperature of the speed reducer 100. The temperature sensor can be provided in any part of the speed reducer 100 or in the conductive particle detecting device 1. For example, the temperature sensor is provided in the detection circuit 50 of the conductive particle detecting device 1.

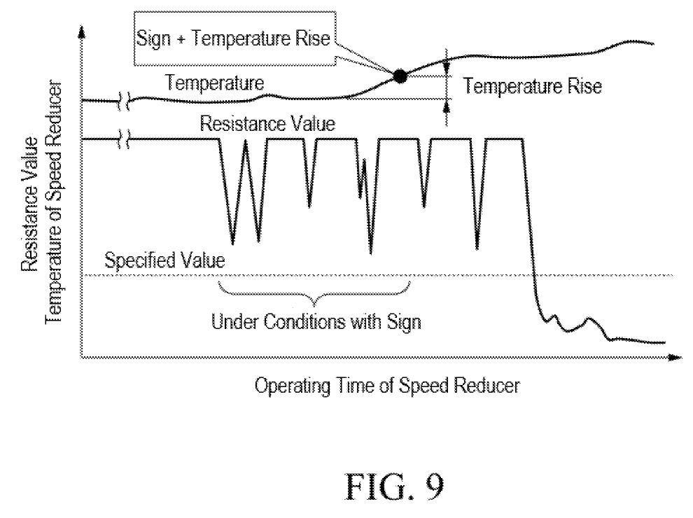

FIG. 9 is a graph showing how the operating time of the speed reducer 100 relates to the change in resistance value detected by the resistance detecting unit 51 and the change in temperature of the speed reducer 100. The vertical axis shown in FIG. 9 indicates the resistance value detected by the resistance detecting unit 51 and the temperature of the speed reducer 100. The horizontal axis shown in FIG. 9 indicates the operating time of the speed reducer 100. Depending on the conditions of use of the conductive particle detecting device 1, it is possible that the over-time metal powder particles are less likely to be deposited on the outer peripheral surface of the cover portion 10. In such a case, as shown in FIG. 9, the resistance value detected by the resistance detecting unit 51 may not reach or fall below the specified value. Therefore, the detection circuit 50 may not determine that the speed reducer 100 has an abnormality.

However, if the resistance value has dropped several times, there may be a sign of an abnormality in the speed reducer 100. Such a situation is hereinafter referred to as a sign of an abnormality in the speed reducer 100. Despite the sign of an abnormality in the speed reducer 100, the speed reducer 100 may be determined to have an abnormality at a timing that is delayed from the appropriate timing.

To address this problem, a temperature sensor can be provided to the conductive particle detecting device 1 to monitor the detection results from the temperature sensor. When there is a sign of an abnormality in the speed reducer 100 and it is determined by the temperature sensor that the temperature of the speed reducer 100 has begun to rise, it is determined that the speed reducer 100 has an abnormality. The reason for this determination is that, for example, an increase in the temperature of the speed reducer 100 leads to a decrease in the viscosity of the lubricant 103, and thus the thickness of the oil film reduces, resulting in poor lubrication.

Therefore, according to the first modification, additional use of the temperature sensor makes it possible to determine an abnormality of the speed reducer 100 with high accuracy.

In the first modification, description was made for the case in which the temperature sensor is additionally used for determining an abnormality of the speed reducer 100. However, this case is not limitative. For example, an acceleration sensor can be added. Vibration of the speed reducer 100 may be detected by the acceleration sensor, and the results of this detection may be used to determine an abnormality of the speed reducer 100.

### Second Modification

In the first modification, description was made for the case in which, for example, a temperature sensor is provided to the detection circuit 50 of the conductive particle detecting device 1. However, this case is not limitative, and the temperature sensor may be mounted on the circuit board 53. This configuration makes it possible to measure the temperature inside the speed reducer 100, for example, the temperature of the lubricant 103. This improves the accuracy in measurement of the temperature of the speed reducer 100. When mounting the temperature sensor on the circuit board 53, a film of polyimide, for example, can be attached on top of the temperature sensor. In this way, the temperature sensor can be protected.

In the case of measuring the temperature of the lubricant 103 in the speed reducer 100, as in the second modification, the speed reducer 100 is determined to have an abnormality when the measured temperature is about 60° to 70°, for example. By contrast, in the case where the temperature sensor is provided on the wall 101a of the casing 101 in the speed reducer 100, the speed reducer 100 is determined to have an abnormality when the measured temperature is about 60°, for example.

### Third Modification

In the above embodiment, description was made for the case in which the cover portion 10 is unrotatable around the support shaft 14b. However, this case is not limitative, and the cover portion 10 may be configured such that its portion around the electrode portions 13 is rotatable around the support shaft 14b. For example, the second cylindrical portion 31 and the second cover legs 32 of the second cover 22 may be divided and configured such that the second cylindrical portion 31 can rotate around the support shaft 14b relative to the first cover 21.

The flow of the lubricant 103 filled in the casing 101 of the speed reducer 100 as a whole is unlikely to be turbulent, and the lubricant 103 may flow in one specific direction at particular locations. In such a case, it may be difficult to allow the over-time metal powder particles to be deposited evenly on the conductive particle detecting device 1 at those particular locations, and the over-time metal powder particles may be deposited unevenly on a part of the cover portion 10. This may cause decrease in detection accuracy of the conductive particle detecting device 1.

To address this problem, in the third modification, the portion of the cover portion 10 around the electrode portions 13 is rotatable around the support shaft 14b. This configuration makes it possible to allow the over-time metal powder particles to be deposited evenly around the entire circumference of the cover portion 10 even when the lubricant 103 in the casing 101 flows in one specific direction. This improves the detection accuracy of the conductive particle detecting device 1 regardless of the flow of the lubricant 103 in the casing 101.

### Other Modifications

The embodiments described herein are not intended to necessarily limit the present invention to any specific embodiments. Various modifications can be made to these embodiments without departing from the true scope and spirit of the present invention.

For example, in the embodiment described above, description was made for the case in which the cover portion 10 is divided into the first cover 21 and the second cover 22. However, this case is not limitative, and the cover portion 10 may have any other shape and configuration. It is also possible that the cover portion 10 is omitted. The requirement is that the electrode portions 13 protrude radially outward from the magnet portions 12. Also, the requirement is that the magnet portions 12 accumulate conductive particles between adjacent ones of the electrode portions 13. For example, even with the cover portion 10 provided, the electrode portions 13 may be provided on the outer peripheral surface of the cover portion 10.

In the above embodiment, description was made for the case in which the electrode portions 13 are separate from the magnet portions 12. However, this case is not limitative, and the electrode portions 13 and the magnet portions 12 may be integrally molded. For example, the electrode portions 13 and the magnet portions 12 may be formed by two-color molding, and only the parts corresponding to the magnet portions 12 may be magnetized. In the embodiment described above, description was made for the case in which the conductive particle detecting device 1 includes four each of first cover legs 24, second cover legs 32, magnet portions 12, and electrode portions 13. However, this case is not limitative, and any configuration is acceptable as long as the conductive particle detecting device 1 includes at least two each of these components. With such arrangement, the resistance detecting unit 51 can detect the resistance between the two electrode portions 13.

In the above embodiment, description was made for the case in which the detection circuit 50 is provided as a detection unit for detecting the resistance between two electrode portions 13 via the magnet portions 12 and determining whether an abnormality has occurred based on the detected resistance. When the resistance detected by the resistance detecting unit 51 reaches or falls below the specified value, the detection circuit 50 determines that the speed reducer 100 experiences an abnormality. However, these cases are not limitative, and the detection circuit 50 may be simply configured such that it outputs a signal at the ON level (for example, light is turned on) when the resistance between the adjacent electrode portions 13 exceeds the specified value. Then, when the detection circuit 50 outputs a signal at the ON level, it may be determined that the speed reducer 100 has an abnormality. The detected resistance may be output in various manners.

In the above-described embodiment, description was made for the case in which the conductive particles are metal powder particles. However, this case is not limitative, and the conductive particles can be any of other various conductive particles than metal powder particles. For example, other metal powder particles include particles of iron-based magnetic and conductive materials, but the conductive particle detecting device 1 can also detect a conductive resin.

In the embodiment described above, the speed reducer 100 is described as an example mechanical device. The speed reducing mechanism 102 is described as an example mechanical mechanism. According to the above description, the conductive particle detecting device 1 is provided in the speed reducer 100. However, these cases are not limitative, and the conductive particle detecting device 1 can be used in gear devices, or other mechanical devices including various mechanical mechanisms.

In the above embodiment, description was made for the case in which the electrode portion 13 is formed of an elastically deformable material. However, this case is not limitative, and the electrode portion 13 may not be elastically deformable. The requirement is that the electrode portion 13 is formed of a material that is non-magnetic and deformable and can be restored after deformation. For example, the electrode portion 13 may be formed of a shape-memory alloy. The shape-memory alloy may be restored at a predetermined temperature or after a predetermined period of time. Other materials that can be restored under predetermined conditions can be used to form the electrode portion 13.

In the embodiments disclosed herein, a member formed of multiple components may be integrated into a single component, or conversely, a member formed of a single component may be divided into multiple components. Irrespective of whether or not the constituent parts are integrated, they are acceptable as long as they are configured to attain the object of the invention.

What is claimed is:

1. A conductive particle detecting device, comprising:
a mounting portion mounted to a mounting object, the mounting object having conductive particles inside; and
a detection unit aligned with the mounting portion and located inside the mounting object, the detection unit being configured to detect the conductive particles,
wherein the detection unit includes:
a plurality of electrode portions;
a magnet portion for accumulating the conductive particles between adjacent ones of the plurality of electrode portions; and
a detection circuit for detecting the conductive particles based on electrical resistance between adjacent ones of the plurality of electrode portions, and
wherein the plurality of electrode portions are formed of a material that is non-magnetic and deformable and can be restored after deformation.

2. The conductive particle detecting device of claim 1, wherein the plurality of electrode portions are formed of an elastically deformable material.

3. The conductive particle detecting device of claim 1,
wherein the mounting portion includes an externally threaded portion, and
wherein each of the plurality of electrode portions extends in a radial direction and protrudes radially outward beyond a root of the externally threaded portion when viewed from an axial direction of the mounting portion.

4. The conductive particle detecting device of claim 3,
wherein the detection unit includes a cover portion having a tubular shape and supporting the plurality of electrode portions,
wherein the cover portion is coaxial with the mounting portion and has slits into which the plurality of electrode portions are inserted,
wherein each of the slits extends obliquely so as to be closer to the mounting portion radially outward, and
wherein each of the plurality of electrode portions includes:
a base portion extending along an inner surface of the cover portion;
a folded portion extending obliquely from a distal end of the base portion, which is located on an opposite side to the mounting portion, so as to be inserted into corresponding one of the slits; and
an electrode body extending radially outward from an end of the folded portion which is located on a radially outer side.

5. The conductive particle detecting device of claim 2,
wherein the mounting portion includes an externally threaded portion, and
wherein each of the plurality of electrode portions extends in a radial direction and protrudes radially outward beyond a root of the externally threaded portion when viewed from an axial direction of the mounting portion.

6. The conductive particle detecting device of claim 5,
wherein the detection unit includes a cover portion having a tubular shape and supporting the plurality of electrode portions,
wherein the cover portion is coaxial with the mounting portion and has slits into which the plurality of electrode portions are inserted,
wherein each of the slits extends obliquely so as to be closer to the mounting portion radially outward, and
wherein each of the plurality of electrode portions includes:
a base portion extending along an inner surface of the cover portion;
a folded portion extending obliquely from a distal end of the base portion, which is located on an opposite side to the mounting portion, so as to be inserted into corresponding one of the slits; and
an electrode body extending radially outward from an end of the folded portion which is located on a radially outer side.
